(19) United States
(12) Patent Application Publication
(10) Pub. No.: US 2013/0293550 A1
(43) Pub. Date: Nov. 7, 2013

(54) METHOD AND SYSTEM FOR ZOOM ANIMATION

(71) Applicant: Business Intelligence Solutions Safe B.V., Amsterdam (NL)

(72) Inventor: Andrew John CARDNO, San Diego, CA (US)

(21) Appl. No.: 13/889,055

(22) Filed: May 7, 2013

Related U.S. Application Data
(60) Provisional application No. 61/643,661, filed on May 7, 2012.

(51) Int. Cl. G06T 5/00; G06T 13/00

(52) U.S. Cl. CPC G06T 5/00; G06T 13/00
USPC 345/428

(57) ABSTRACT

A method of developing from a first animated sequence of images having a first zoom factor a second animated sequence of images having a second zoom factor different to the first zoom factor, the method comprising the steps of: rendering the first animated sequence of images at a first resolution within a first display area, determining an area of the first animated sequence of images that is to be developed as at least part of a second animated sequence of images having the second zoom factor, adjusting the determined area of the first animated sequence of images for display in a second display area, and rendering the second animated sequence of images at the first resolution in the second display area and subsequently changing the resolution of the second animated sequence of images to a second resolution different to the first resolution.

### CROSS REFERENCE TO RELATED APPLICATION

This application claims priority to U.S. Ser. No. 61/643,661, titled A METHOD AND SYSTEM FOR ZOOM ANIMATION, filed May 7, 2012, the disclosure of which is hereby incorporated by reference in its entirety.

FIELD

The present disclosure relates to a method and system for zoom animation. In particular, the present disclosure relates to a method and system of developing zoomed images for animated sequences of images with varying resolution.

### BACKGROUND

When applying a zoom factor to a static image, one known technique is to zoom in or out of the image using the same level of resolution by enlarging or reducing the size of the image in the viewing space. That is, a portion of a single resolution image is merely increased or reduced in size without changing the resolution of the portion of the image being zoomed.

An improvement on the standard zooming technique described above is to provide multiple layers of images having different levels of resolution. Therefore, when a user zooms in to an image, a new image is rendered using the next level of resolution. However, the rendering of images in this way is time consuming as the whole image is refreshed at the new resolution level each time the user zooms in or out.

Deep Zoom is an implementation of the Seadragon Software technology for use in Microsoft Silverlight and Seadragon Ajax applications. It provides a zooming mechanism for static images by creating a hierarchy of images that have an increasing resolution. When zooming in, a portion of the original low resolution image is first displayed and subsequently a higher resolution image is then added into the displayed image to provide increased resolution. However, this application can only be applied to static images.

Data visualization systems generally handle vast amounts of data in order to create complex data visualizations using various different data analysis techniques. In order to better represent the data analysis results, animation techniques may be utilized to create visualizations that represent the movement of data against one or more variables, such as for example, time, people, product, money etc. By animating a series of data values, the user gets a better idea of how the data is changing with respect to the one or more variables. As more and more data becomes available for analysis, it becomes increasingly beneficial to be able to zoom in and out of the data visualizations to view specific areas of the visualization in increased detail.

Current data visualization systems merely provide a basic zoom function for static images, where the zoom function merely increases the size of the image being zoomed without changing the associated resolution. A similar mechanism may also be applied to an animated visual representation. However, as the complexity of data visualizations increases, a lack of resolution on an animated image having a zoom factor applied to it can result in a loss of information for the user. That is, certain information may not be clearly rendered in the data visualization resulting in the information being overlooked.

An object of the present disclosure is to provide an improved method and system of developing zoomed animated images.

Each object is to be read disjunctively with the object of at least providing the public with a useful choice.

The present disclosure aims to overcome, or at least alleviate, some or all of the afore-mentioned problems.

### SUMMARY

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e. they will be taken to mean an inclusion of the listed components which the use directly references, and possibly also of other non-specified components or elements.

According to one aspect, the present disclosure provides a method of developing from a first animated sequence of images having a first zoom factor a second animated sequence of images having a second zoom factor different to the first zoom factor, the method comprising the steps of: rendering the first animated sequence of images at a first resolution within a first display area, determining an area of the first animated sequence of images that is to be developed as at least part of a second animated sequence of images having the second zoom factor, adjusting the determined area of the first animated sequence of images for display in a second display area, and rendering the second animated sequence of images at the first resolution in the second display area and subsequently changing the resolution of the second animated sequence of images to a second resolution different to the first resolution.

According to a further aspect, the present disclosure provides a data visualization rendering system arranged to develop from a first animated sequence of images having a first zoom factor a second animated sequence of images having a second zoom factor different to the first zoom factor, the system including: a rendering module arranged to render the first animated sequence of images at a first resolution within a first display area, a zoom detection module arranged to determine an area of the first animated sequence of images that is to be developed as at least part of a second animated sequence of images having the second zoom factor, a size control module arranged to adjust the determined area of the first animated sequence of images for display in a second display area, and a resolution control module arranged to render the second animated sequence of images at the first resolution in the second display area and subsequently changing the resolution of the second animated sequence of images to a second resolution different to the first resolution.

According to particular embodiments of the present disclosure an improved method and system is provided that animates sequences of data visualization images and enables those animated images to be rendered using a zoom factor in an efficient manner.

### BRIEF DESCRIPTION OF THE DRAWINGS

Embodiments of the present disclosure will now be described, by way of example only, with reference to the accompanying drawings, in which:

FIG. 1 shows a system block diagram according to an embodiment of the present disclosure;

FIG. 2 shows a sequence of images generated according to an embodiment of the present disclosure;

FIG. 3 shows a further sequence of images generated according to an embodiment of the present disclosure;

FIG. 4 shows yet a further sequence of images generated according to an embodiment of the present disclosure; and

FIG. 5 shows a set of animated sequences of images at different resolutions according to an embodiment of the present disclosure.

### DETAILED DESCRIPTION

### First Embodiment

Embodiments of the present disclosure are described herein with reference to a system adapted or arranged to perform a method for generating animated sequences of images.

In summary, the system includes at least a disclosure, one or more memory devices or an interface for connection to one or more memory devices, input and output interfaces for connection to external devices in order to enable the system to receive and operate upon instructions from one or more users or external systems, a data bus for internal and external communications between the various components, and a suitable power supply. Further, the system may include one or more communication devices (wired or wireless) for communicating with external and internal devices, and one or more input/output devices, such as a display, pointing device, keyboard or printing device.

The processor is arranged to perform the steps of a program stored as program instructions within the memory device. The program instructions enable the various methods of performing the disclosure as described herein to be performed. The program instructions may be developed or implemented using any suitable software programming language and toolkit, such as, for example, a C-based language. Further, the program instructions may be stored in any suitable manner such that they can be transferred to the memory device or read by the processor, such as, for example, being stored on a computer readable medium. The computer readable medium may be any suitable medium, such as, for example, solid state memory, magnetic tape, a compact disc (CD-ROM or CD-R/W), memory card, flash memory, optical disc, magnetic disc or any other suitable computer readable medium.

The system is arranged to be in communication with external data storage systems or devices in order to retrieve the relevant data.

It will be understood that the system herein described includes one or more elements that are arranged to perform the various functions and methods. The following portion of the description is aimed at providing the reader with an example of a conceptual view of how various modules and/or engines that make up the elements of the system may be interconnected to enable the functions to be implemented. Further, the following portion of the description explains in system related detail how the steps of the herein described method may be performed. The conceptual diagrams are provided to indicate to the reader how the various data elements are processed at different stages by the various different modules and/or engines.

It will be understood that the arrangement and construction of the modules or engines may be adapted accordingly depending on system and user requirements so that various functions may be performed by different modules or engines to those described herein, and that certain modules or engines may be combined into single modules or engines.

It will be understood that the modules and/or engines described may be implemented and provided with instructions using any suitable form of technology. For example, the modules or engines may be implemented or created using any suitable software code written in any suitable language, where the code is then compiled to produce an executable program that may be run on any suitable computing system. Alternatively, or in conjunction with the executable program, the modules or engines may be implemented using any suitable mixture of hardware, firmware and software. For example, portions of the modules may be implemented using an application specific integrated circuit (ASIC), a system-on-a-chip (SoC), field programmable gate arrays (FPGA) or any other suitable adaptable or programmable processing device.

The methods described herein may be implemented using a general purpose electronic computing system specifically programmed to perform the described steps. Alternatively, the methods described herein may be implemented using a specific electronic computer system such as a data visualization computer, a database query computer, a graphical analysis computer, a retail environment analysis computer, a gaming data analysis computer, a manufacturing data analysis computer, a business intelligence computer, a social network data analysis computer, etc., where the computer has been specifically adapted to perform the described steps on specific data captured from an environment associated with a particular field.

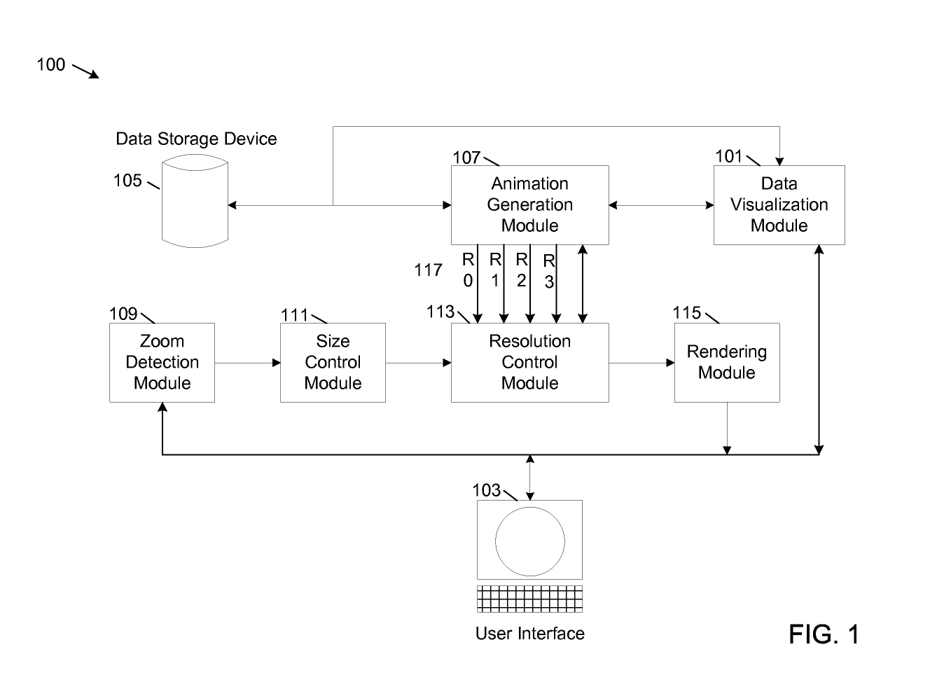

FIG. 1 shows a block diagram of a data visualization animation system arranged to develop animated sequences of images based on a selected zoom factor.

A data visualization system 101 is provided that generates graphical representations of data according to instructions received from a user via a user interface 103.

For example, the data visualization system may be a system as described in METHODS, APPARATUS AND SYSTEMS FOR DATA VISUALISATION AND RELATED APPLICATIONS earlier filed by the applicant and published as WO2009/154484, which is hereby incorporated by reference.

The data visualization system may further be enabled to animate sequences of images, which are rendered and displayed on the user interface 103. That is, graphical visualizations or visual documents may be created or generated in a manner that animates the data. For example, data retrieved over a period of time may be animated to visualize how the data is changing temporally. Alternatively, data retrieved from different locations may be animated to visually represent how the data changes by location or geographically. It will be understood that the data may be animated using other defined variables.

The data visualization system 101 is in communication with a data storage device 105. The data storage module may be any suitable type of data storage system. For example, it may be an enterprise data warehouse (EDW), a data mart, a database, a storage array or any other suitable device or groups of devices that can store data for later retrieval. Further, the data storage module may be a cache memory used to temporarily store incoming data captured in real time. For example, the incoming data may be streaming data or a sequence of displayable stationary images.

The data provided as an input to the system may be of any suitable type of data, for example, real world data including, but not limited to, gaming or gambling data associated with a gaming environment such as a casino, event data, test or quality control data obtained from a manufacturing environment, business data retrieved from an accounting system, sales data retrieved from a company database, data received or accumulated from a social network, etc. All this data may be received by the system in real time (e.g. by receiving streaming data) in a cache memory or may be stored in a more permanent manner.

Upon the data visualization system 101 receiving instructions to create an animated sequence of images as a graphical representation, instructions are provided to an animation generating module 107, which is arranged to generate the animated representation for display on the user interface 103.

The user interface enables the user to select an area, for example a part or portion, of the animated representation which they want to zoom in on.

Conversely, the user may also select the whole area being visualized in order to choose to zoom out from an image sequence that is already being shown in a zoomed in format.

Therefore, the user chooses or identifies an area of a first animated sequence of images that is to be shown in either a zoomed in or zoomed out format. That is, the first animated sequence of images before selection is shown using a first zoom factor and the second set of images is shown using a second zoom factor, where the first and second zoom factors are different. For example, the first zoom factor may be greater than the second zoom factor in the case where the user has chosen to zoom out of the data visualization animated sequence. Alternatively, the second zoom factor may be greater than the first zoom factor in the case where the user has chosen to zoom into the data visualization animated sequence.

When zooming in, the area or portion of the first animated sequence of images selected may be adjusted to fit the display area. When zooming out, the whole area of the first animated sequence of images being displayed prior to zooming out is reduced in size to form at least part of the second animated sequence of images (the zoomed out sequence) within the display area.

A zoom detection module 109 detects from data received from the user interface whether the animated sequence of images currently being rendered and displayed on the user interface is to have a zoom factor applied to it. If the sequence is to have a zoom factor applied to it, the zoom detection module detects the area or portion of the image sequence that is to have the zoom factor applied and what level the zoom factor is to be based, for example, on data provided by a user via the user interface.

That is, for example, when zooming in the zoom detection module may detect an area or portion of an animated sequence of images that the user has requested the system zooms in on. Alternatively, for example, when zooming out the zoom detection module may detect that a user has requested the system zooms out of the animated sequence of images that is currently being shown. The system may detect the selected area or portion by monitoring the use of a pointing device or system forming part of the user interface, such as a mouse for example. By detecting that the pointing device has been used to select an area which is to form part of the zoomed in or out area, this identified area is then subsequently modified as described in more detail below. It will be understood that the zoom detection module may detect one or more mouse clicks, mouse movements, touch sensitive screen presses or key presses, for example, to determine an area which is to be the subject of the zoom function.

For example, the zoom detection module may detect a user selecting an on screen option for zooming out. Alternatively, the zoom detection module may detect a user selecting an on screen option for zooming in. When zooming in, the system may automatically zoom in to a central portion of the animated sequence. Alternatively, when zooming in, the system may display instructions to the user that they must select an area or portion to be zoomed in on. The portion or area may be selected by entering co-ordinates or by selecting an area using a pointing device or touch screen, for example.

The zoom detection module 109 is in communication with a size control module 111. The size control module 111 is arranged to control the image size of the selected area so that the selected area is rendered within the display area being used to display the zoomed in or out animated sequence of images, as will be explained in more detail below. It will be understood that the term “selected area” not only applies to a portion of the image that the user has selected for zooming in on, but also applies to the whole (or at least part) of the animated sequence of images when a user selects the option of zooming out of an image.

A resolution control module 113 is in communication with the size control module 111 and animation generation module 107. The resolution control module 113 may, for example, receive a number of image sequences 117 which are suitable for rendering at different resolution factors R0, R1, R2 and R3. These sequences may be generated by the animation generation module and/or received by the resolution control module concurrently, simultaneously, in synchronization, separately or at different times. One or more of the different sequences may be retrieved from the animation generation module 107 to be forwarded to the rendering module 115 depending on the instructions received from the user interface 103, zoom detection module 109 and size control module 111. Therefore, the resolution control module 113 is arranged to fully control the resolution of the animated sequences of images before and after zooming in/out, as will be explained in more detail below.

A rendering module 115 is in communication with the resolution control module 113 and user interface 103 and is arranged to render the image sequences for display on the user interface 103.

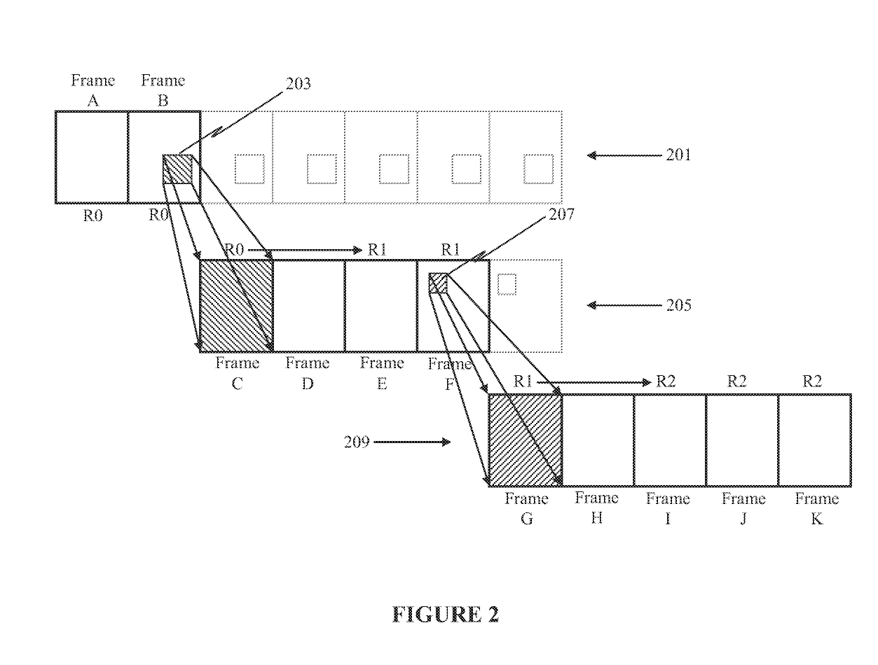

FIG. 2 shows an example of how the system handles a zoom in request on a first sequence of images.

Row 201 shows a number of frames that are produced to create a first sequence of images. That is, the display area displays rendered frame A followed by frame B and subsequent frames to display the animated sequence. The images in this first sequence are rendered using a first resolution value R0. That is, the first resolution value, R0 defines the number of pixels that are to be used to display each frame in the sequence of images.

A user selects an area 203 of the image in frame B that the system is to zoom in on, for example, by dragging a mouse device. This selected area is detected by the zoom detection module based on the co-ordinates detected by the system through the use of the pointing device. For example, the area 203 is highlighted by the user by clicking and dragging a mouse over the area 203 and selecting “zoom in” as an option via the user interface.

According to this embodiment, the selected area 203 is expanded immediately to fit into the display area of frame C, the immediately subsequent frame to be displayed. The area 203 is adjusted by the size control module to fit completely within the display area. The adjustment may include automatically adjusting the aspect ratio of the image, or may maintain the original aspect ratio and display a border around the zoomed in image to take into account the difference between the aspect ratio of the display area and the aspect ratio of the selected area.

The zoomed in image displayed in the display area of frame C, is initially displayed using the same resolution value of the original image, i.e. resolution value R0. This enables the user to immediately see the zoomed in visualization animation without having to wait for the system to update the resolution of the image.

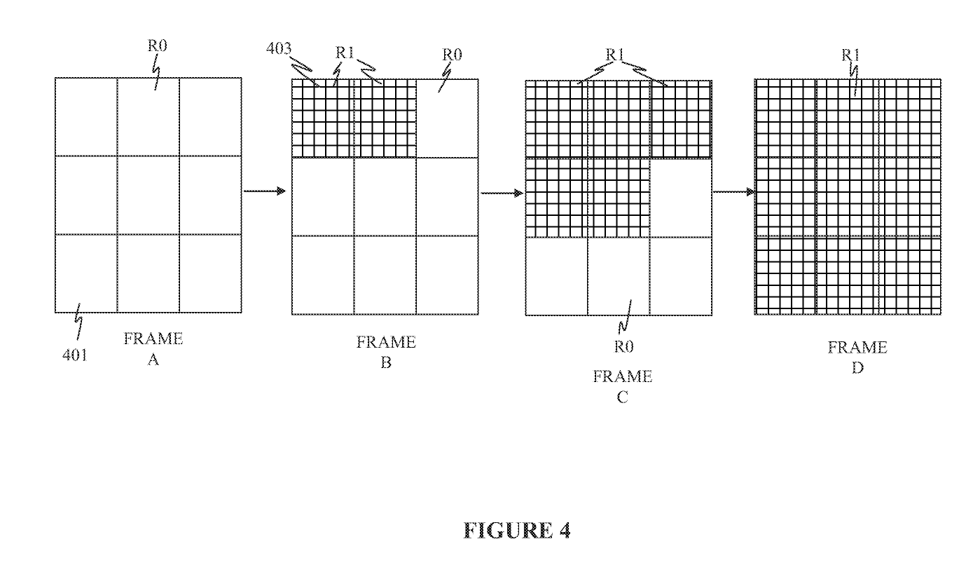

Subsequently, the resolution of the image is gradually updated by the resolution control module, as described in more detail below with reference to FIG. 4. According to this embodiment, the resolution update is performed over three frames. However, it will be understood that the resolution update may occur over any defined period of time or number of frames.

According to this embodiment, frame C displays the zoomed in area 203 at the original resolution value. Frame D displays the zoomed in area 203 at an increased resolution value greater than R0. Frame E displays the zoomed in area 203 at a predefined zoomed in resolution value R1 used by the system for a first level zoom factor. All subsequent frames (e.g. Frame F) of this zoomed in sequence 205 are then displayed using the R1 resolution value.

FIG. 2 also shows what happens if the user then selects a further area 207 in frame F that they want the system to zoom in on. The selected area 207 is expanded to fit into the display area of frame G, the immediately subsequent frame to be displayed. The area 207 is adjusted by the size control module to fit completely within the display area.

The zoomed in image displayed in the display area of frame G is initially displayed using the same resolution value of the previous image prior to zooming, i.e. resolution value R1.

Subsequently, the resolution of the image is gradually updated by the resolution control module, as described in more detail below with reference to FIG. 4. According to this embodiment, the resolution update is performed over three frames. However, it will be understood that the resolution update may occur over any defined period of time or number of frames.

According to this embodiment, frame G displays the zoomed in area 207 at the original resolution value. Frame H displays the zoomed in area 207 at an increased resolution value greater than R1. Frame I displays the zoomed in area 207 at a predefined zoomed in resolution value R2 used by the system for a second level zoom factor. All subsequent frames of this zoomed in sequence 209 (Frames J and K etc) are then displayed using the R2 resolution value.

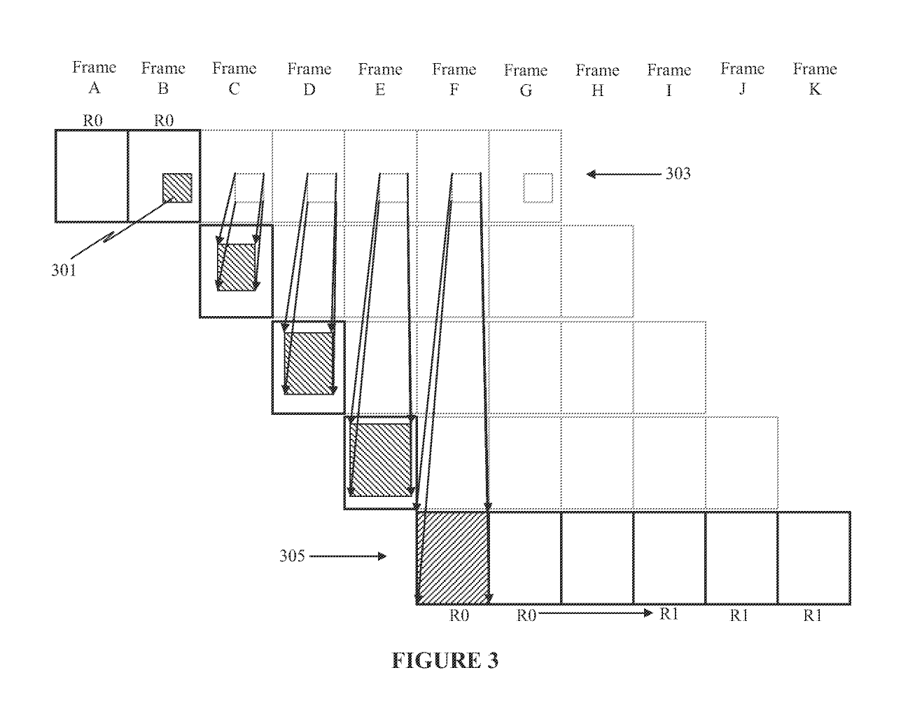

FIG. 3 shows a further example of how the system handles a zoom in request on a first sequence of images.

Row 303 shows a sequence of image frames that are currently being rendered and displayed on a display screen of the user interface. The images in this first sequence are rendered using a first resolution value R0. That is, the first resolution value, R0 defines the number of pixels that are to be used to display the sequence of images.

A user selects an area 301 of the image in frame B that the system is to zoom in on, and this is detected by the zoom detection module. That is, for example, the area 301 is highlighted by the user by clicking and dragging a mouse over the area 301 and selecting “zoom in” as an option via the user interface.

According to this embodiment, the selected area 301 is gradually expanded over a number of subsequent frames. The number of frames required before the selected area is fully expanded to fit within the display area may be predefined. Alternatively, the number of frames may be defined by a predetermined time limit for adjusting the size of the selected area. As shown in FIG. 3, this example shows the selected area 301 being gradually expanded in size over a number of frames (namely Frames C, D and E) until the selected area has been fully expanded in frame F. The image being rendered and displayed within the selected area as it is being adjusted in size is a larger version of the image that would have been shown in the selected area if the size was not adjusted. That is, the gradually increasing display area for the zoomed in image continues to show animated images using the selected image information from within frames C through to F.

The original image shown in sequence 303 may be rendered by the rendering module and displayed on the user interface as a background layer, while the subsequent sequence 305 may be rendered by the rendering module and displayed on the user interface as a foreground layer. The foreground layer may then gradually be adjusted in size so that it overlays the background layer.

The size control module adjusts the size of the selected area over the sequence of frames until the selected area fits within the final display area of frame F. The size control may include automatically adjusting the aspect ratio of the selected area, or may maintain the original aspect ratio and display a border around the zoomed in image to take into account the difference between the aspect ratio of the display area and the aspect ratio of the selected area.

The fully zoomed in image displayed in the display area of frame F, is initially displayed using the same resolution value of the original image, i.e. resolution value R0. Also, the same resolution value R0 is used for all the interim zoomed in images from frames C through to E. This enables the user to immediately see the zoomed in visualization animation without having to wait for the system to update the resolution of the images.

Subsequently, the resolution of the images is gradually updated by the resolution control module, as described in more detail below. According to this embodiment, the resolution update is performed over four frames. However, it will be understood that the resolution update may occur over any defined period of time or number of frames.

According to this embodiment, frames F & G display the zoomed in area 301 at the original resolution value. Frame H displays the zoomed in area 301 at an increased resolution value greater than R0. Frame I displays the zoomed in area 301 at a predefined zoomed in resolution value R1 used by the system for a first level zoom factor. All subsequent frames (e.g. Frames J & K) of this zoomed in sequence 305 are then displayed using the R1 resolution value.

Although the above examples provide a detailed explanation of how to zoom in to an image using the herein described system, it will be understood that the system may also zoom out of an image using the same methods in reverse. That is, upon a user selecting an option to zoom out of a sequence of images being rendered at a first resolution, the system adjusts the size of the zoomed in image to fit into the zoomed out image at its correct location. That is, for example, the system reduces the size of the current zoomed in image so that it becomes a proportional size of the zoomed out image. The size adjustment may be immediate (as in FIG. 2) or over a period of time or a number of frames (as in FIG. 3). The resolution value for the zoomed out image is not immediately reduced upon zooming out but is subsequently changed over a predetermined period of time or number of frames from a higher resolution to a lower resolution.

It can be seen from the above examples that the original display area for the original sequence of images may be the same size as the display area for the zoomed in sequence of images. Alternatively, the rendering module may render the original and subsequent display areas at different sizes. For example, the original display area may be rendered so it is larger than the subsequent zoomed in area, or vice versa.

Also, the examples discussed above in relation to FIGS. 2 and 3 show the original and subsequent display area for the original and zoomed in sequence of images to be the same area in a display area. However, it will be understood that the original and subsequent display areas may be located at different points in image space enabling both the original and zoomed in/out images to be viewed simultaneously.

FIG. 4 provides a graphical example of how the resolution of the image sequence may be updated over a number of frames.

Frame A includes a number of sections 401, each section showing a portion of the whole image for that frame in the sequence. Effectively, the image in the frame is made up of a composite set of smaller images. In frame A each of the sections in the frame are rendered at a first resolution value R0. Each segment is gradually updated to a higher resolution value R1 as shown in FIG. 4. That is, subsequent frame B is shown with two sections (403 & 405) that have been rendered using a higher resolution value R1. The remaining segments in frame B remain being visualized at resolution value R0. The next frame, frame C is shown with five segments being rendered using the higher resolution value R1, The remaining segments remain at resolution value R0. Finally, frame D in the sequence is shown with all segments rendered at the higher resolution value R1.

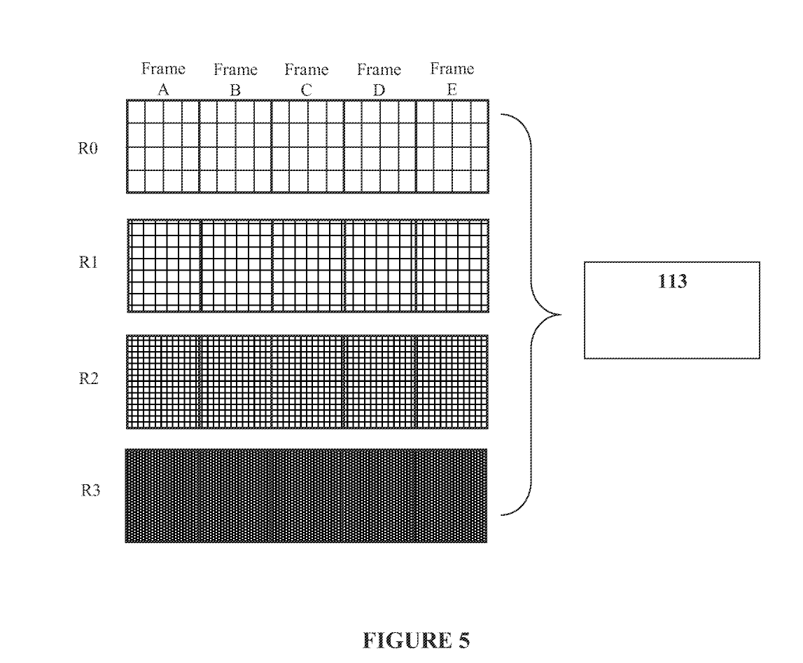

FIG. 5 shows in more detail a number of image sequences that are available for rendering using different resolution factors R0, R1, R2 and R3. The resolution increasingly varies from R0 which is the lowest resolution through to R3 which is the highest resolution, where R1 and R2 are interim resolution factors. The different sequences of images are generated by and obtained from the animation generation module 107 and transmitted, passed or communicated to the resolution control module 113. The resolution control module 113 determines which of these sequences of images are to be rendered based on the level of zoom detected by the zoom detection module 109. It will be understood that the generation of the different sequences at the different resolution factors is not continuous and the image sequences at different resolution factors are only output from the animation generation module as required. Therefore, as the resolution control module receives instructions to increase or decrease the resolution based on the level of zoom requested through the user interface, the output from the animation generation module varies based on instructions received from the resolution control module, as shown for example in FIG. 4.

It will be understood that the embodiments of the present disclosure described herein are by way of example only, and that various changes and modifications may be made without departing from the scope of disclosure.

1. A method, implemented on an electronic computing system, of developing from a first animated sequence of images having a first zoom factor a second animated sequence of images having a second zoom factor different to the first zoom factor, the method comprising the steps of:
on the electronic computing system, rendering the first animated sequence of images at a first resolution within a first display area;
determining an area of the first animated sequence of images that is to be developed as at least part of a second animated sequence of images having the second zoom factor;
adjusting the determined area of the first animated sequence of images for display in a second display area; and
rendering the second animated sequence of images at the first resolution in the second display area and subsequently changing the resolution of the second animated sequence of images to a second resolution different to the first resolution.

2. The method of claim 1, wherein the first display area and second display area are one and the same.

3. The method of claim 1, wherein the first display area and second display area are different.

4. The method of claim 1, wherein the first display area is larger than the second display area.

5. The method of claim 1, wherein the first display area is smaller than the second display area.

6. The method of claim 1, wherein the first display area is the same size as the second display area.

7. The method of claim 1, wherein the first resolution is a higher resolution than the second resolution.

8. The method of claim 1, wherein the first resolution is a lower resolution than the second resolution.

9. The method of claim 1, wherein the resolution of the second animated sequence of images is changed over a pre-set number of frames of the second animated sequence of images.

10. The method of claim 1, wherein during the step of adjusting the determined portion of the first animated sequence of images, the method further comprises the steps of:
rendering the first animated sequence of images in the first display area as a background layer;
rendering the determined portion of the second animated sequence of images in the second display area as a foreground layer; and
gradually adjusting the size of the second display area so that the determined portion overlays the first animated sequence of images.

11. The method of claim 10, wherein the size of the second display area is adjusted over a pre-set number of frames of the first or second animated sequence of images.

12. The method of claim 1, wherein the first display area and second display area are initially different, and the adjustment of the determined portion causes the first display area and second display area to become the same.

13. The method of claim 1, wherein the determined portion is detected by detecting one or more mouse clicks, mouse movements or key presses.

14. The method of claim 1, wherein the first or second animated sequence of images is received in the form of streaming data.

15. The method of claim 1, wherein the first or second animated sequence of images is received in the form of a sequence of displayable stationary images.

16. A data visualization rendering system arranged to develop from a first animated sequence of images having a first zoom factor a second animated sequence of images having a second zoom factor different to the first zoom factor, the system including:
a processor;
a memory;
a rendering module arranged to render the first animated sequence of images at a first resolution within a first display area;
a zoom detection module arranged to determine an area of the first animated sequence of images that is to be developed as at least part of a second animated sequence of images having the second zoom factor;
a size control module arranged to adjust the determined area of the first animated sequence of images for display in a second display area; and
a resolution control module arranged to render the second animated sequence of images at the first resolution in the second display area and subsequently changing the resolution of the second animated sequence of images to a second resolution different to the first resolution.

17. The system of claim 16, wherein the first display area and second display area are one and the same.

18. The system of claim 16, wherein the first display area and second display area are different.

19. The system of claim 16, wherein the first display area is larger than the second display area.

20. The system of claim 16, wherein the first display area is smaller than the second display area.

21. The system of claim 16, wherein the first display area is the same size as the second display area.

22. The system of claim 16, wherein the first resolution is a higher resolution than the second resolution.

23. The system of claim 16, wherein the first resolution is a lower resolution than the second resolution.

24. The system of claim 16, wherein the resolution of the second animated sequence of images is changed over a pre-set number of frames of the second animated sequence of images.

25. The system of claim 16, wherein the rendering module is further arranged to:
render the first animated sequence of images in the first display area as a background layer; and
render the determined portion of the second animated sequence of images in the second display area as a foreground layer,
wherein the size adjustment module is further arranged to gradually adjust the size of the second display area so that the determined portion overlays the first animated sequence of images.

26. The system of claim 25, wherein the size of the second display area is adjusted over a pre-set number of frames of the first or second animated sequence of images.

27. The system of claim 16, wherein the first display area and second display area are initially different, and the adjustment of the determined portion causes the first display area and second display area to become the same.

28. The system of claim 16, wherein the determined portion is detected by detecting one or more mouse clicks, mouse movements or key presses.

29. The system of claim 16, wherein the first or second animated sequence of images is received in the form of streaming data.

30. The system of claim 16, wherein the first or second animated sequence of images is received in the form of a sequence of displayable stationary images.
